(19) United States
(12) Patent Application Publication
(10) Pub. No.: US 2018/0101245 A1
(43) Pub. Date: Apr. 12, 2018

(54) Control Apparatus and Method of Operation

(71) Applicant: COOPER TECHNOLOGIES COMPANY, HOUSTON, TX (US)

(72) Inventors: Ray Mihir Rao Sewlochan, Port Coquitlam (CA); Dung Chi Trinh, Surrey (CA); Bruce Edward Butler, Maple Ridge (CA)

(73) Assignee: COOPER TECHNOLOGIES COMPANY, HOUSTON, TX (US)

(21) Appl. No.: 15/291,122

(22) Filed: Oct. 12, 2016

(51) Int. Cl. G06F 3/0338

(52) U.S. Cl. CPC G06F 3/0338

(57) ABSTRACT

A control apparatus includes a visual display and input devices that are movable between a neutral state and non-neutral state. The control apparatus visually outputs on the visual display a visual output that is representative of a non-neutral state of an input device and whose position on the visual display is representative of the location on the control apparatus where the non-neutral input device is situated. The control apparatus can be configured to control any of a variety of pieces of equipment and employs a configuration file that is deployed on the control apparatus in order to configure it to enable it to communicate with a particular piece of equipment. Equipment-specific firmware drivers serve as an interface between the input devices and a graphics engine without the graphics engine needing to know anything about the piece of equipment itself.

### BACKGROUND

### Field

The disclosed and claimed concept relates generally to the control of a piece of equipment and, more particularly, to a graphical neutral check for a piece of equipment.

### Related Art

Numerous types of equipment and control devices therefor are known in the relevant art. While in some situations the control apparatus is situated directly on the piece of equipment, in numerous other situations the control apparatus is remote from the piece of equipment. Pieces of equipment such as skid steer loaders, tow trucks having cranes, and concrete pumping systems that receive a flow of uncured concrete from a concrete mixer are examples of pieces of equipment that have been known to employ a control apparatus that is remote from the rest of the piece of equipment for any of a variety of reasons. For instance, an operator with a good view of a work site can remotely operate a skid steer loader for digging, loading, and moving material without having to be physically situated on the skid steer loader itself, which is desirable because it is less tiring and can permit an operator to physically remain at a location remote from an otherwise hazardous environment. A person may wish to operate the crane portion of a tow truck from a location near a vehicle that is being towed at which chains, cables, and the like are affixed to the vehicle rather than having to leave such location and return to the tow truck in order to perform certain lifting and other operations. An operator of a concrete pumping system may wish to control the pumping of concrete at a remote location where the concrete is actually being dispensed. These and numerous other examples exist of situations where a control apparatus is remote from a piece of equipment that has motors, engines, and the like that perform the useful work of the piece of equipment. While such control apparatuses have been generally effective for their intended purposes, they have not been without limitation.

By way of example, when operating a piece of equipment, it is desirable to avoid starting the piece of equipment with one of its driven devices being engaged, such as in the way it is desirable to avoid starting a tractor with one of its PTOs being engaged with the engine. This is desirable for any of a variety of reasons, such as in order to avoid having the starter motor have to drive both the engine and the entire drivetrain through and including the implement that is connected with the PTO, and to avoid unintended operation of the implement during startup, and other such examples will be apparent. It thus is known to provide some type of an indication, such as an illuminated warning lamp, and to refrain from starting the piece of equipment in a situation where one of its physical controls is in a non-neutral state. That is, the physical controls of a piece of equipment typically are movable between a neutral state (such as an OFF state or a DISENGAGED state, etc.) and a non-neutral state (such as an ON state or an ENGAGED state or an OPERATIONAL state), and it is desirable to avoid starting a piece of equipment when its physical controls are in a state other than a neutral state.

This problem is exacerbated in a situation where the control apparatus is situated remote from the piece of equipment. For instance, the operator typically is situated remote from the piece of equipment and cannot easily determine the condition of each of the physical controls. Other limitations exist, and improvements thus would be desirable.

### SUMMARY

An improved control apparatus that meets these and other needs advantageously includes one or more input devices and a visual display. The input devices are movable between a neutral state and non-neutral state and are usable to provide input to the control apparatus and to a piece of equipment connected therewith. The control apparatus advantageously visually outputs on the visual display a visual output that is representative of a non-neutral state of an input device and whose position on the visual display is representative of the location on the control apparatus where the non-neutral input device is situated. The control apparatus has an architecture that permits it to be configured to control any of a variety of pieces of equipment and employs a configuration file that is deployed on the control apparatus in order to configure it to enable it to communicate with a particular piece of equipment. The control apparatus employs generic firmware drivers for the input devices that are customized through the use of the configuration file to form equipment-specific firmware drivers that serve as an interface between the input devices and a graphics engine of the control apparatus, which enables the graphics engine to output graphical objects that are representative of the neutral states and the non-neutral states of the various input devices without the graphics engine needing to know anything about the piece of equipment itself.

Accordingly, an aspect of the disclosed and claimed concept is to provide a control apparatus that provides a graphical neutral check that provides a visual output that is representative of a non-neutral state of an input device and whose position on the visual display is representative of a location on the control apparatus where the input device is situated.

Another aspect of the disclosed and claimed concept is to provide an improved control apparatus and method that are usable to control any of a variety of pieces of equipment.

Another aspect of the disclosed and claimed concept is to provide an improved control apparatus and method that rapidly visually advises an operator of an input device that is in a non-neutral state and that enables the operator to rapidly return the input device to a neutral state in order to permit the piece of equipment that is connected therewith to be switched to an ON state or an OPERATIONAL state.

Accordingly, an aspect of the disclosed and claimed concept is to provide an improved method of operating a control apparatus, the control apparatus including a processor apparatus having a processor and a storage, an input apparatus having a number of input devices movable between a neutral state and a non-neutral state, and an output apparatus having a visual display structured to receive output signals from the processor apparatus. The method can be generally stated as including determining that at least one input device of the number of input devices is in a non-neutral state, and depicting on the visual display a visual output that is representative of the non-neutral state of the at least one input device and whose position on the visual display is representative of a location on the control apparatus where the at least one input device is situated.

Another aspect of the disclosed and claimed concept is to provide an improved control apparatus, the general nature of which can be stated as including a processor apparatus having a processor and a storage, an input apparatus having a number of input devices movable between a neutral state and a non-neutral state, and an output apparatus having a visual display structured to receive output signals from the processor apparatus, the storage having stored therein a number of routines which, when executed on the processor, cause the control apparatus to perform operations that can be generally stated as including determining that at least one input device of the number of input devices is in a non-neutral state, and depicting on the visual display a visual output that is representative of the non-neutral state of the at least one input device and whose position on the visual display is representative of a location on the control apparatus where the at least one input device is situated.

### BRIEF DESCRIPTION OF THE DRAWINGS

A further understanding of the disclosed and claimed concept will be gained from the following Description when read in conjunction with the accompanying drawings wherein:

FIG. 1 is a depiction of an improved control apparatus in accordance with the disclosed and claimed concept;

FIG. 1A is an enlargement of a visual display of the control apparatus of FIG. 1;

FIG. 2 is a schematic depiction of the control apparatus of FIG. 1;

FIG. 3 is a diagrammatic depiction of the way in which a generic firmware driver is converted through the use of a configuration file into an equipment-specific firmware driver;

FIG. 4 is a diagrammatic view of the control apparatus of FIG. 1; and

FIG. 5 is a flow chart depicting certain aspects of an improved method of operating the control apparatus of FIG. 1.

Similar numerals refer to similar parts throughout the specification.

### DESCRIPTION

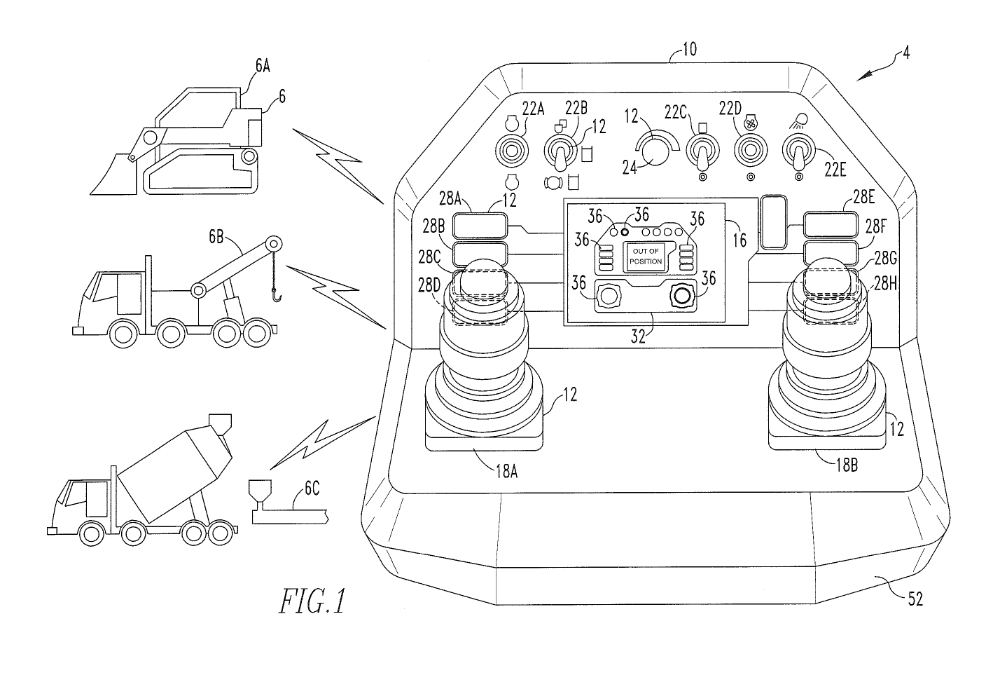

An improved control apparatus 4 in accordance with the disclosed and claimed concept is depicted generally in FIGS. 1, 2, and 4. The control apparatus 4 is configured to be placed in operative communication with any of a variety of pieces of equipment, three of which are depicted in a schematic fashion in FIG. 1 and which are indicated at the numerals 6A, 6B, and 6C, which may be collectively or individually referred to herein with the numeral 6. In the depicted exemplary embodiment, control apparatus 4 is capable of being in wireless or wired operative communication with the piece of equipment 6 that it has been configured to control. That is, and as will be set forth in greater detail below, the control apparatus 4 has a platform that enables it to be capable of operative communication with any of the pieces of equipment 6 but which, once configured, communicates with only a single particular piece of equipment 6. It is noted, however, that the control apparatus can be configured to control separately (i.e., one at a time) more than one instance of a particular piece of equipment and alternatively to simultaneously control a plurality of pieces of equipment, whether more than one instance of the particular piece of equipment or different pieces of equipment. As will be set forth in greater detail below, the control apparatus 4, once configured, is capable of being placed in operative communication with the piece of equipment 6, but such operative communication between the control apparatus 4 and the piece of equipment 6 is prevented until a neutral check is performed by the control apparatus 4 on itself and it is determined that the control apparatus 4 is in a neutral state.

The control apparatus 4 includes a housing 10 upon which are situated a number of input devices 12 and a visual display 16. As employed herein, the expression “a number of” shall refer generally to any non-zero quantity, including a quantity of one. In the depicted exemplary embodiment, the input devices 12 comprise a plurality of input devices that are schematically depicted in FIG. 1 as including a pair of joysticks indicated at the numerals 18A and 18B, which may be collectively or individually referred to herein with the numeral 18, a plurality of toggle switches that are indicated at the numerals 22A, 22B, 22C, 22D, and 22E, which may be collectively or individually referred to herein with the numeral 22, a variable input 24, and a plurality of pushbutton switches that are indicated at the numerals 28A, 28B, 28C, 28D, 28E, 28F, 28G, and 28H, which may be collectively or individually referred to herein with the numeral 28. The input devices can include other types of input devices such as paddle switches, touchpads, roller balls, and virtually any other type of input device.

The various input devices 12 are different from one another in a variety of ways. For instance, the joysticks 18 are movable in a forward-backward plane and are also movable in a left-right plane and may also be rotated and may additionally have a pushbutton thereon. The toggle switches 22 are movable among two positions or three positions or more depending upon their desired functions. The variable input 24 in the depicted exemplary embodiment is continuously variable between an initial position and a final position. The pushbutton switches 28 are each switchable between, for instance, an ON position and an OFF position.

At any given time, each of the input devices 12 is in a state, and the state is either a neutral state or a non-neutral state. In the depicted exemplary embodiment, any given input device 12 has a single definition of its neutral state, and if it is in any state other than the neutral state it is considered to be in a non-neutral state. Depending upon the particulars of the given application, it is possible that the neutral state could be a range of states or a plurality of states, and if its condition is other than in one of these neutral states it is considered to be in a non-neutral state. As will be set forth in greater detail below, the definitions of what constitutes a neutral state and/or what constitutes a non-neutral state is defined when the control apparatus 4 is customized to make it capable of being placed in operative communication with a particular piece of equipment 6.

As can be understood from FIG. 1A, the visual display 16 visually outputs thereon an outline 32 that is intended to be a visual representation of the housing 10. As can further be seen in FIG. 1A, the visual display 16 has output thereon a plurality of visual outputs 36 that are visually representative of the input devices 12 and of the state, i.e., neutral or non-neutral, of such input devices 12. One way in which the visual outputs 36 are representative of the input devices 12 is by positioning each of the visual outputs 36 at a position on or with respect to the outline 32 that is representative of the location on the housing 10 where a corresponding one of the input devices 12 is situated.

The visual outputs 36 in the depicted exemplary embodiment indicate the state of the input devices 12 by depicting a neutral state of an input device 12 with a relatively thinner line and by depicting a non-neutral state of an input device 12 with a relatively thicker line. For instance, FIG. 1A depicts a non-neutral state of the joystick 18B and the toggle switch 22B with relatively thicker lines on the visual display 16 than the joystick 18A and the other toggle switches 22, respectively. It is understood that the non-neutral state of any given input device 12 can be depicted in any of a variety of fashions to distinguish from a neutral state by providing visual outputs that are tailored to convey desirable information. For example, the visual display 16 could provide in green color one or more visual outputs 36 that are representative of an input device 12 in a neutral state and can provide in red color one or more visual outputs 36 that are representative of an input device 12 in a non-neutral state. Other examples will be apparent, such as by employing flashing or non-flashing visual output 36, by employing visual outputs that are relatively bright or relatively dim, by employing visual outputs 36 that are either depicting merely as an outline or depicted with a filled background, etc. In short, the visual outputs 36 can be configured to distinguish between a neutral state and a non-neutral state of an input device 12 in any of a variety of fashions, and the foregoing are merely examples of how this can be done. Moreover, it is understood that certain input devices 12 might have more than two possible states, i.e., more than merely a neutral state and a non-neutral state, and any such additional state can likewise be visually output on the visual display 16 through the use of an appropriate visual output 36.

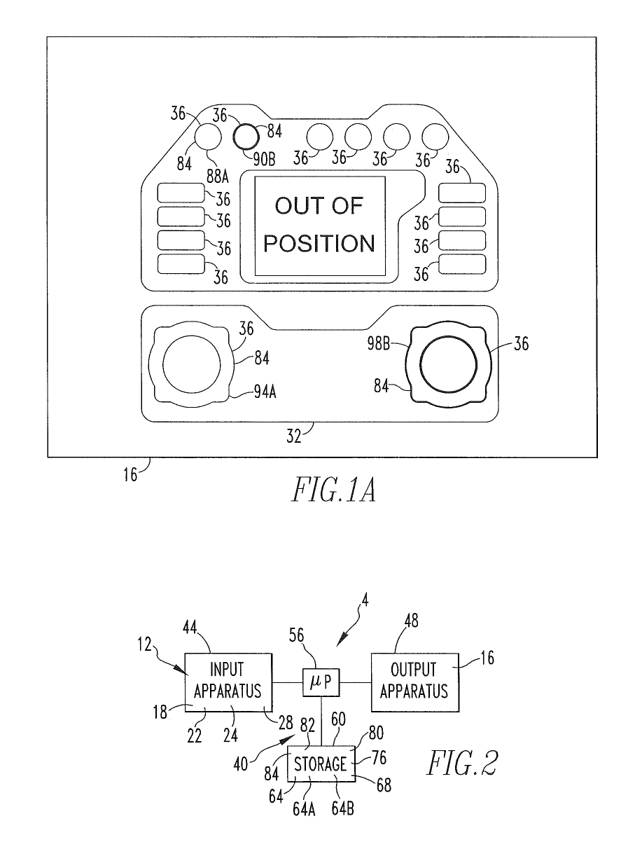

As can be understood from FIG. 2, the control apparatus 4 can be schematically stated to include a processor apparatus 40, an input apparatus 44, and an output apparatus 48. The input apparatus 44 includes the input devices 12, which are changeable between a neutral state and a non-neutral state and are configured to provide input signals to the processor apparatus 40. The output apparatus 48 can be said to include the visual display 16 and can further be said to receive output signals from the processor apparatus 40. The control apparatus 4 can be said to further include a wireless transceiver 52 that is schematically depicted in FIG. 1.

The processor apparatus 40 includes a processor 56 and a storage 60. The processor 56 can be any of a wide variety of processors, such as a microprocessor or other processor. The storage 60 can be any of a wide variety of storage devices, both transitory and non-transitory, and can include any one or more of RAM, ROM, EPROM, FLASH, and the like without limitation. The storage 60 has stored therein a number of routines 64 that include instructions that are executable on the processor 56 to cause the control apparatus 4 to perform any of a number of operations. The routines 64 can be in the form of code or in other forms and are intended to include software, firmware, and other such types of objects that are capable of execution. Two of the routines 64 are indicated herein as a platform task A routine 64A and a platform task B routine 64B, among other routines 64, which will be set forth in greater detail below.

At least initially, the control apparatus 4 has stored therein a set of generic firmware drivers 68 that are, in the depicted exemplary embodiment, among the routines 64, but that may be in other forms without departing from the spirit and scope of the disclosed and claimed concept. That is, the generic firmware drivers 68 may be routines 64 that are executed on the processor 56 or may be other bits of instruction that are executed on other processors of the control apparatus 4 without limitation. The generic firmware drivers 68 each have a number of fields 72 which, in the generic firmware drivers 68, are in a generic state. As can be understood from FIG. 3, when a configuration file 76 is deployed on the control apparatus 4, the fields 72 become updated by data or values or other objects from the configuration file 76 to form an equipment-specific firmware driver 80. By way of example, one of the generic firmware drivers 68 may include a piece of code or other instructions that are configured to cooperate with one of the input devices 12 having five pins, and another generic firmware driver 68 might be configured to cooperate with another input device having eight pins. By way of further example, the plurality of input devices 12 might include two of the aforementioned input devices having five pins and might further include three input devices having the aforementioned eight pins.

When the configuration file 76 is deployed and loaded on the control apparatus 4, an instance of each generic firmware driver 68 is created for each appropriate input device 12 and its fields 72 are updated to form an equipment-specific firmware driver 80 for that particular input device 12. Depending upon the needs of the particular application, such instantiation of the generic firmware drivers 68 and transformation into the equipment-specific firmware drivers 80 can occur every time the control apparatus 4 is switched to an ON state, or it can merely be done once when the control apparatus 4 is switched to the ON state for the first time, or it can be done in any of a variety of other fashions without limitation. In the depicted exemplary embodiment, the equipment-specific firmware drivers 80 are executed on the processor 56 as routines 64, but in other embodiments the equipment-specific firmware drivers 80 can be executed on other processors, or they can be executed in any of a wide variety of fashions, without limitation and without departing from the spirit and scope of the disclosed and claimed concept.

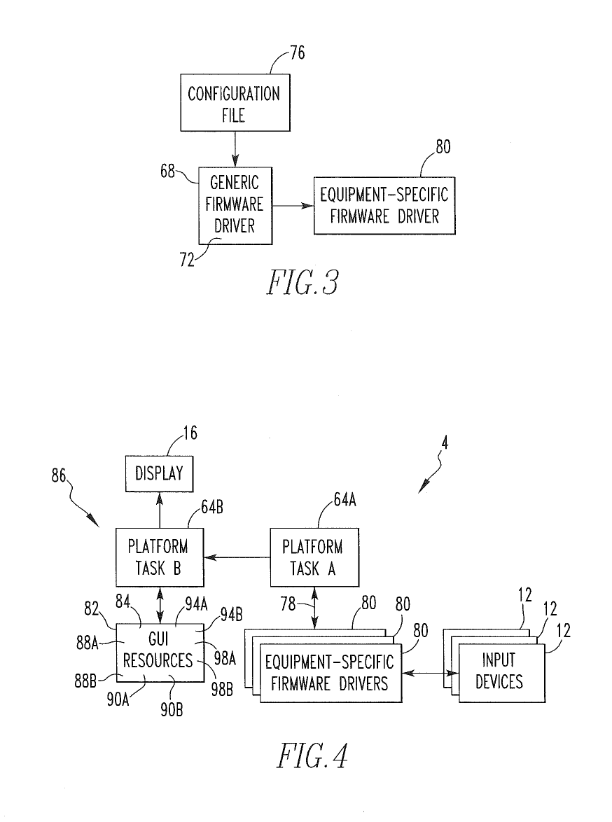

As can be understood from FIG. 4, the control apparatus 4 further includes a GUI resources folder 82 that is stored in the storage 60, and the GUI resources folder 82 has a plurality of graphical objects 84 stored therein. The graphical objects 84 will be described in greater detail below and are capable of being visually output on the visual display 16 by the platform task B routine 64B. In the depicted exemplary embodiment, the platform task B routine 64B, the GUI resources folder 82, and the visual display 16 can be said to form a graphics engine 86. In the depicted exemplary embodiment, the graphics engine 86 advantageously need not know the specific type or nature of the piece of equipment 6 with which the control apparatus 4 is intended to be placed in operative communication, thereby simplifying programming, storage, and processing.

The graphical objects 84 are actually stored logically as pairs of graphical objects 84, and each pair of graphical objects corresponds with a corresponding input device 12. One graphical object 84 or the other of the pair of graphical objects 84 is visually output on the visual display 16 depending upon the state of the input device 12, i.e., neutral or non-neutral. That is, and as will be set forth in greater detail below, the platform task B routine 64B receives a data stream that includes, for each of the input devices 12, an identification of the pair of graphical objects 84 that corresponds with the input device 12 and a value that is representative of the state of the input device 12, and the platform task B routine 64B employs the contents of the data stream to retrieve from the GUI resources folder 82 the appropriate graphical object 84 from each of the pairs of graphical objects 84 that corresponds with the state of the corresponding input device 12 as received via the data stream.

More particularly, when the control apparatus 4 is started or when it is desired to begin to operate the piece of equipment 6, the platform task A routine 64B interrogates, in turn, each of the equipment-specific firmware drivers 80, and such interrogation is represented by the downward-pointing arrowhead of a line 78 in FIG. 4 that extends between the platform task A routine 64A and the equipment-specific firmware drivers 80. As each equipment-specific firmware driver 80 is interrogated by the platform task A routine 64A, the equipment-specific firmware driver 80 interrogates its corresponding input device 12 in order to determine the state of the corresponding input device 12. By way of example, one equipment-specific firmware driver 80 might be associated with a particular input device 12 having five pins and may measure the voltage of the pin designated as PIN5 with respect to ground, and once it has measured such voltage it may determine whether the measured voltage is within a predetermined voltage range that is indicative of a neutral state of the corresponding input device 12. If the measured device falls within the predetermined voltage range, the corresponding input device 12 is determined by the equipment-specific firmware driver 80 to be in a neutral state, but if the measured voltage is determined to be other than within the predetermined range, the equipment-specific firmware driver 80 will determine that the corresponding input device 12 is in a non-neutral state. The equipment-specific firmware driver 80 will then send to the platform task A routine 64A a data element that is representative of the state, perhaps the value 0 for “neutral” and the value 1 for “non-neutral”, and will additionally send another value that is representative of the pair of graphical objects 84 that are stored in the GUI resources folder 82 and which correspond with the corresponding input device 12.

As each equipment-specific firmware driver 80 is interrogated by the platform task A routine 64A, each such equipment-specific firmware driver 80 will return to the platform task A routine 64A a value that is representative of the state of the corresponding input device 12 and another value that is representative of the pair of graphical objects 84 that is associated with the corresponding input device 12. The values that are collectively returned by the equipment-specific firmware drivers 80 with each interrogation form the data stream to the platform task A routine 64A.

In some circumstances, such as in the case of the joystick 18, the corresponding equipment-specific firmware driver 80 might detect several parameters of the joystick 18. For instance, the equipment-specific firmware driver 80 might detect as one parameter a pin voltage that is representative of the position of the joystick 18 along the forward-rearward plane, and the result may be, for instance, a determination that that particular parameter is neutral. However, the same equipment-specific firmware driver 80 might test as another parameter a voltage on another pin of the joystick 18 that is representative of the position of the joystick 18 along the left-right axis, and it might be determined by the equipment-specific firmware driver 80 that this parameter of the joystick 18 is non-neutral. In the depicted exemplary embodiment, when any given input device 12 has a plurality of such parameters, the input device 12 is considered to be in a non-neutral state if any one or more of the parameters is considered to be in a non-neutral state. Furthermore, in the depicted exemplary embodiment, all of the various neutral and non-neutral states of a given input device 12, and a representation of the corresponding pair of graphical objects 84, are communicated to the platform task A routine 64A, and the platform task A routine 64A determines from all of the measured parameters whether the input device 12 is in a neutral state or a non-neutral state. In other embodiments, such a determination can be made by the equipment-specific firmware driver 80 itself.

The values that are representative of pairs of graphical objects 84 and associated states are then communicated from the platform task A routine 64A to the platform task B routine 64B. The platform task B routine 64B then identifies each pair of graphical objects 84 and retrieves from that pair of graphical objects 84 the particular graphical object 84 that corresponds with the associated state value that was obtained from the platform task A routine 64A. The retrieved graphical objects 84 from the stored pairs of graphical object 84 are then sent to the visual display 16 for visual output thereon.

By way of example, the pairs of graphical objects 84 might include a pair of graphical objects that are indicated at the numerals 88A and 88B, and these might correspond with the toggle switch 22A. Another pair of the graphical objects 84 might include a pair of graphical objects that are indicated at the numerals 90A and 90B, and these might be associated with the toggle switch 22B. While the pairs of graphical objects 88A and 88B and the pair of graphical objects 90A and 90B may all be stored in the GUI resources folder 82, only one of the pair 88A and 88B and only one of the pair 90A and 90B will be output at any given time on the visual display 16, and this will be based upon the data stream that was received by the platform task B routine 64B.

For instance, FIG. 1A depicts on the visual display 16 the graphical object 88A and the graphical object 90B being output as visual outputs 36 on the visual display 16, among other visual outputs 36. The graphical object 88A is depicted as being a relatively thinner circle and is thus representative of the toggle switch 22A being in the neutral state, and it is output at a position on the outline 32 that corresponds with the location on the housing 10 where the toggle switch 22A is situated. Likewise, the outputting of the graphical object 90B is representative of the toggle switch 22B being in its non-neutral state by the graphical object 90B being depicted with a relatively thicker circle (i.e., drawn with a relatively thicker line than the graphical object 88A), and it is depicted at a position on the outline 32 that corresponds with the location where the toggle switch 22B is situated on the housing 10. As can be readily understood, the graphical object 88B, which is not being output in FIG. 1A, would be output at the same place where the graphical object 88A is currently being in FIG. 1A, but it would have a relatively thicker appearance, similar to the appearance of the graphical object 90B, in order to be representative of the toggle switch 22A being in a non-neutral state. It can further be understood that the graphical object 90A, when output, would be representative of the neutral state of the toggle switch 22B and would have the appearance of the graphical object 88A, except it would be situated where the graphical object 90B is currently being output in FIG. 1A.

In a similar fashion, the pairs of graphical objects 84 might include a pair of graphical objects that are indicated at the numerals 94A and 94B and that correspond with the left joystick 18A. Another pair of graphical objects 84 might be indicated at the numerals 98A and 98B and might be associated with the right joystick 18B. FIG. 1A depicts the graphical object 94A and the graphical object 98B being visually output as visual outputs 36, among other visual outputs 36, and as representing the joystick 18A being in a neutral state and as further representing the joystick 18B being in a non-neutral state by virtue of the graphical object 94A being drawn with a relatively thin line and the graphical object 98B being drawn with a relatively thick line. Moreover, the graphical object 94A is visually output at a position on the outline 32 that corresponds with the location on the housing 10 where the joystick 18A is situated, and the graphical object 98B is visually output at a position on the outline 32 that corresponds with the location on the housing 10 where the joystick 18B is situated. The graphical object 94B would have the same appearance as the graphical object 98B except would be output in place of the graphical object 94A at the position where the graphical object 94A is situated in FIG. 1A with respect to the outline 32. Likewise, the graphical object 98A would have the same appearance as the graphical object 94A but would be output at the position with respect to the outline 32 where the graphical object 98B is depicted in FIG. 1A. As noted above, the pairs of graphical objects 84 can be in any form that is appropriate to provide a visual distinction between a neutral state and a non-neutral state, such as by employing pairs of graphical objects 84 of different colors, different line thicknesses, having one flash versus one be fixed, and in any of a wide variety of other fashions.

The interrogation of the equipment-specific firmware drivers 80 by the platform task A routine 64A is envisioned to operate as a loop and to continually provide to the platform task B routine 64B sets of values that are representative of a pair of graphical objects 84 and a corresponding state, both of which correspond with an associated input device 12, in order to continually update the visual display 16. While any of the input devices 12 is in a non-neutral state, the control apparatus 4 prevents the wireless transceiver 52 from being energized and thus prevents wireless communication of any kind between the control apparatus 4 and the piece of equipment 6. Alternatively or additionally, the non-neutral state of the control apparatus 4 can prevent the piece of equipment 6 from being energized or could otherwise prevents some type of operation thereof or could perform or prevent some other activity, without limitation. Still alternatively, the control apparatus 4 in a non-neutral state can permit non-operational communications between the control apparatus 4 and the piece of equipment 6 while preventing operational communications therebetween. In this regard, basic non-operational communications between the control apparatus 4 and the piece of equipment 6 could be allowed, such as to confirm that a communication path exists therebetween, to perform equipment checks and to confirm states and the like, but operational communications that would cause the piece of equipment 6 to become energized or to become operational or to change its condition in any way would be prevented. Once the platform task A routine and/or the platform task B routine 64A and 64B determine that all of the input devices 12 are in their neutral state, the piece of equipment 6 is permitted to be energized, meaning that the operation of such piece of equipment 6 is no longer prevented by the control apparatus 4.

By causing the generic firmware drivers 68 to be transformed into equipment-specific firmware driver 80 by the use of the configuration file 76, the control apparatus 4 can be manufactured without specific regard to the particular piece of equipment 6 with which the control apparatus 4 is intended to eventually be in operative communication, and rather the configuration file 76 can simply be tailored to the particular piece of equipment 6. The configuration file 76 also permits tailoring to a variant use of the same piece of equipment 6. For example, the configuration file 76 could permit a left-handed version or a right handed version of the layout of the input devices 12. Alternatively or additionally, the configuration file 76 could offer either a simple mode or an expert mode of operation, i.e., the configuration file 76 could enable limited functionality vs. extended functionality.

Moreover, the control apparatus 4 can be reconfigured using a different configuration file 76 in order to enable it to be placed in operative communication with a different piece of equipment 6. Furthermore, since the equipment-specific firmware drivers 80 obtain from the corresponding input devices 12 information that enables the equipment-specific firmware drivers 80 to ascertain a neutral state or a non-neutral state of the input device 12, and since the equipment-specific firmware drivers 80 also have stored therein an association between the input device 12 and an identification of the pair of graphical objects 84 that correspond with such input device 12, the equipment-specific firmware drivers 80 can communicate to the platform task A routine 64A values that are merely representative of a pair of graphical objects 84 and a state that are associated with a particular input device 12. The platform device task A routine 64A and the graphics engine 86 thus need not include or be aware of any of the details regarding the configuration file 76 or the piece of equipment 6, which simplifies programming and processing needs. The configuration file 76 thus effectively defines the neutral states and the non-neutral states of the various input devices 12 as well as the pairs of graphical objects 84 that are associated with each such input device 12.

It is understood that in other embodiments the control apparatus 4 may include fewer than all of the input devices 12 that are depicted in FIG. 1 and/or may include other such input devices 12. In this regard, it is understood that some of the input devices 12 that are depicted in FIG. 1 might be optional in a given application, and the control apparatus 4 thus might be manufactured without one or more of the depicted input devices 12. In such a situation, the GUI resources folder 82 might have stored therein pairs of graphical objects 84 that are associated with all possible input devices 12, but the platform task B routine 64B would never retrieve from the GUI resources folder 82 a graphical object 84 from a pair that is associated with an input device 12 that happens to be nonexistent on any particular control apparatus 4. Other implementations will be apparent.

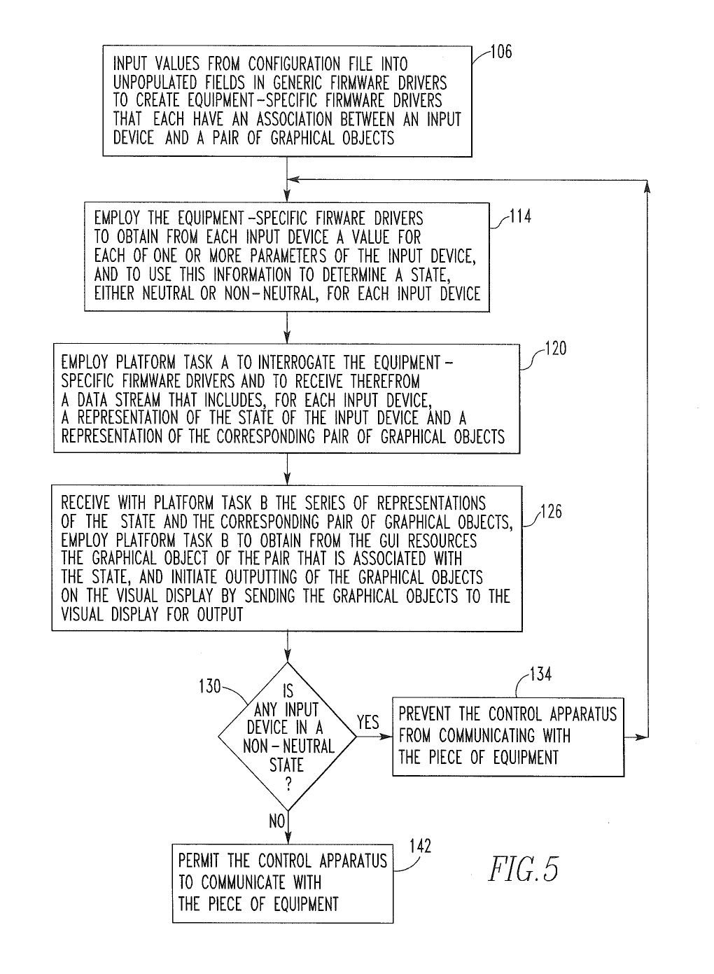

FIG. 5 depicts in a flowchart certain aspects of an improved method in accordance with the disclosed and claimed concept. Processing begins, as at 106, where various values or other objects from the configuration file 76 are input into the generic fields 72 in the generic firmware drivers 68 in order to create the updated fields 72 that are a part of the equipment-specific firmware drivers 80. It is reiterated that each such equipment-specific firmware drivers 80 include an association between an input device 12 and a pair of graphical objects 84 that are stored in the GUI resources folder 82. Processing then continues, as at 114, where the equipment-specific firmware drivers 80 are employed to obtain from the corresponding input devices 12 a value for each of one or more parameters of the input device 12, such as a measured voltage, resistance, other value, etc., and this information is used by the equipment-specific firmware drivers 80 to determine a state for each such input device 12, which, as noted above, is either neutral or non-neutral in the depicted exemplary embodiment.

Processing then continues, as at 120, where the platform task A routine 64A is employed to interrogate the equipment-specific firmware drivers 80 and to receive therefrom as a data stream a series of sets of values, with one value of a set being an identifier that is representative of a pair of graphical objects 84 that corresponds with a given input device 12, and with the other value in the set being representative of a state of the given input device 12. Such data stream might be represented by the upward-pointing arrowhead in the line 78.

Processing then continues, as at 126, where the platform task B routine 64B receives the series of sets of representations of state and corresponding pair of graphical objects 84, and the task B routine 64B then uses such data to retrieve from the GUI resources folder 82 the particular graphical object 84 of the indicated pair that is associated with the indicated state of the input device 12. The platform task B routine 64B then initiates outputting of the retrieved graphical objects 84 on the visual display 16 by sending the graphical objects 84 to the visual display 16 for output. In addition to the advantages set forth herein, the visual outputting of the retrieved graphical objects 84 on the visual display 16 provides information that is graphical in nature and that does not rely solely upon linguistic content, and therefore it can be operated to advantage by persons will diverse language skills and thus advantageously avoids language barriers and can be used by diverse operators in diverse countries.

It is determined, as at 130, whether any given input device 12 is in a non-neutral state. If any such input device 12 is in a non-neutral state, processing continues, as at 134, where operation of the wireless transceiver 52 is prevented, which eliminates any possibility of startup of the piece of equipment 6. Processing can then continue, as at 114. However, if it is determined at 130 that none of the input devices 12 is in a non-neutral state, the wireless transceiver 52 is energized which, in turn, can permit startup of the piece of equipment 6, as at 142. Further variations will be apparent.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A method of operating a control apparatus, the control apparatus including a processor apparatus having a processor and a storage, an input apparatus having a number of input devices movable between a neutral state and a non-neutral state, and an output apparatus having a visual display structured to receive output signals from the processor apparatus, the method comprising:
determining that at least one input device of the number of input devices is in a non-neutral state; and
depicting on the visual display a visual output that is representative of the non-neutral state of the at least one input device and whose position on the visual display is representative of a location on the control apparatus where the at least one input device is situated.

2. The method of claim 1 wherein the control apparatus is structured to be placed in operative communication with a piece of equipment, and further comprising, responsive to the determining that the at least one input device is in the non-neutral state, preventing operational communications between the control apparatus and the piece of equipment.

3. The method of claim 1, further comprising:
depicting on the visual display a visual representation of at least a portion of the control apparatus; and
outputting the visual output at a position on the visual representation that is representative of the location on the control apparatus where the at least one input device is situated.

4. The method of claim 1 wherein the number of input devices are structured to provide input signals to the processor apparatus, and wherein the storage has stored therein a number of graphical objects that can be visually output on the visual display, each graphical object of the number of graphical objects corresponding with a corresponding input device of the number of input devices, and further comprising visually displaying as the visual output a graphical object of the number of graphical objects that corresponds with the at least one input device.

5. The method of claim 4 wherein the number of graphical objects are arranged in a number of pairs of graphical objects, each pair of graphical objects of the number of pairs corresponding with a corresponding input device of the number of input devices, one graphical object of the pair being representative of the corresponding input device in the neutral state when visually output on the visual display, the other graphical object of the pair being representative of the corresponding input device in the non-neutral state when visually output on the visual display, a particular pair of graphical objects of the number of pairs corresponding with the at least one input device, and further comprising visually displaying as the visual output the other graphical object of the particular pair.

6. The method of claim 5, further comprising:
receiving a data stream comprising a first data element that comprises an identification of the particular pair and a second data element that comprises a representation of the non-neutral state; and
responsive to the receiving of the data stream:
retrieving from the storage the other graphical object of the particular pair, and
initiating the visual displaying of the other graphical object of the particular pair.

7. The method of claim 6 wherein the storage has stored therein a number of routines that are executable on the processor, a routine from among the number of routines comprising an association between the at least one input device and the particular pair of graphical objects, and further comprising:
employing the routine to obtain the non-neutral state from the at least one input device thereof; and
employing the routine to generate the data stream based as least in part upon the non-neutral state and the association.

8. The method of claim 7 wherein the storage at least initially has stored therein a number of generic routines each having a number of fields that are in a generic state, and further comprising:
receiving on the processor apparatus at least a portion of a configuration file having a number of values; and
updating in a generic routine of the number of generic routines at least some of fields of the number of fields with at least some of the values of the number of values to form the routine.

9. The method of claim 8 wherein the control apparatus is structured to be placed in operative communication with a piece of equipment, and further comprising receiving on the processor apparatus as the at least portion of the configuration file at least a portion of a particular configuration file whose number of values is tailored to the piece of equipment.

10. The method of claim 8 wherein the control apparatus is structured to be placed in operative communication with any of a plurality of pieces of equipment, and further comprising receiving on the processor apparatus as the at least portion of the configuration file at least a portion of a specific configuration file whose number of values is tailored to a specific piece of equipment from among the plurality of pieces of equipment to cause the control apparatus to be structured to be placed in operative communication with the specific piece of equipment.

11. A control apparatus comprising:
a processor apparatus having a processor and a storage;
an input apparatus having a number of input devices movable between a neutral state and a non-neutral state; and
an output apparatus having a visual display structured to receive output signals from the processor apparatus;
the storage having stored therein a number of routines which, when executed on the processor, cause the control apparatus to perform operations comprising:
determining that at least one input device of the number of input devices is in a non-neutral state; and
depicting on the visual display a visual output that is representative of the non-neutral state of the at least one input device and whose position on the visual display is representative of a location on the control apparatus where the at least one input device is situated.

12. The control apparatus of claim 11 wherein the control apparatus is structured to be placed in operative communication with a piece of equipment, and wherein the operations further comprise, responsive to the determining that the at least one input device is in the non-neutral state, preventing operational communications between the control apparatus and the piece of equipment.

13. The control apparatus of claim 11 wherein the operations further comprise:
depicting on the visual display a visual representation of at least a portion of the control apparatus; and
outputting the visual output at a position on the visual representation that is representative of the location on the control apparatus where the at least one input device is situated.

14. The control apparatus of claim 11 wherein the number of input devices are structured to provide input signals to the processor apparatus, and wherein the storage has stored therein a number of graphical objects that can be visually output on the visual display, each graphical object of the number of graphical objects corresponding with a corresponding input device of the number of input devices, and wherein the operations further comprise visually displaying as the visual output a graphical object of the number of graphical objects that corresponds with the at least one input device.

15. The control apparatus of claim 14 wherein the number of graphical objects are arranged in a number of pairs of graphical objects, each pair of graphical objects of the number of pairs corresponding with a corresponding input device of the number of input devices, one graphical object of the pair being representative of the corresponding input device in the neutral state when visually output on the visual display, the other graphical object of the pair being representative of the corresponding input device in the non-neutral state when visually output on the visual display, a particular pair of graphical objects of the number of pairs corresponding with the at least one input device, and wherein the operations further comprise visually displaying as the visual output the other graphical object of the particular pair.

16. The control apparatus of claim 15 wherein the operations further comprise:
receiving a data stream comprising a first data element that comprises an identification of the particular pair and a second data element that comprises a representation of the non-neutral state; and
responsive to the receiving of the data stream:
retrieving from the storage the other graphical object of the particular pair, and
initiating the visual displaying of the other graphical object of the particular pair.

17. The control apparatus of claim 16 wherein a routine from among the number of routines comprises an association between the at least one input device and the particular pair of graphical objects, and wherein the operations further comprise:
employing the routine to obtain the non-neutral state from the at least one input device thereof; and
employing the routine to generate the data stream based as least in part upon the non-neutral state and the association.

18. The control apparatus of claim 17 wherein the storage at least initially has stored therein a number of generic routines each having a number of fields that are in a generic state, and wherein the operations further comprise:
receiving on the processor apparatus at least a portion of a configuration file having a number of values; and
updating in a generic routine of the number of generic routines at least some of fields of the number of fields with at least some of the values of the number of values to form the routine.

19. The control apparatus of claim 18 wherein the control apparatus is structured to be placed in operative communication with a piece of equipment, and wherein the operations further comprise receiving on the processor apparatus as the at least portion of the configuration file at least a portion of a particular configuration file whose number of values is tailored to the piece of equipment.

20. The control apparatus of claim 18 wherein the control apparatus is structured to be placed in operative communication with any of a plurality of pieces of equipment, and wherein the operations further comprise receiving on the processor apparatus as the at least portion of the configuration file at least a portion of a specific configuration file whose number of values is tailored to a specific piece of equipment from among the plurality of pieces of equipment to cause the control apparatus to be structured to be placed in operative communication with the specific piece of equipment.
